(19) United States
(12) Patent Application Publication
(10) Pub. No.: US 2009/0152261 A1
(43) Pub. Date: Jun. 18, 2009

(54) Packaging machine with induction heating

(75) Inventor: Luciano Capriotti, Bad Groenenbach (DE)

Correspondence Address: WILLIAM D. BRENEMAN, ESQ.;BRENEMAN & GEORGES, 3150 COMMONWEALTH AVENUE, ALEXANDRIA, VA, 22305, US

(73) Assignee: MULTIVAC Sepp Haggenmueller GmbH & Co. KG, Wolfertschwenden (DE)

(21) Appl. No.: 12/314,436

(22) Filed: Dec. 10, 2008

(30) Foreign Application Priority Data
Dec. 11, 2007 (DE) 10 2007 059 812.4

(51) Int. Cl. H05B 6/10

(52) U.S. Cl. 219/635

(57) ABSTRACT

The present invention relates to a packaging machine for packaging packages, preferably trough-shaped packages, to be filled with goods, wherein a heating system is provided. The packaging machine is characterized in that the heating system is designed as an induction heating unit which is associated with a processing tool, and wherein the induction heating unit is provided in such a way that inductively generated eddy currents may be produced in the processing tool by the induction heating unit in order to directly heat the processing tool.

The present invention relates to a packaging machine according to the preamble of Claim 1.

### BACKGROUND

Commercial packaging machines for packaging goods often include heating, shaping, and/or sealing tools for producing and/or sealing a preferably trough-shaped package which is to be filled or is already filled with goods.

Tray sealers are frequently used as packaging machines, in which, for example, prefabricated packaging troughs or packaging shells are filled with goods and subsequently sealed, preferably using a film.

Deep-drawing machines or roller machines are known as a second important type of packaging machine. In these machines, a preferably trough- or shell-shaped packaging container to be filled with goods is produced in the desired shape and size, and is sealed after filling.

As materials for producing the packaging, plastic films are generally used, which are heated using appropriate heating devices and shaped using appropriate shaping tools, usually by means of a deep-drawing process. Depending on the size and/or type and/or thickness of the film to be processed, upstream base heating as well as preheating must be provided to achieve sufficient heat penetration of the film to be deformed.

The packaging filled with goods is usually sealed by heating a cover film (top film), and optionally heating the filled shell at the regions provided for producing a sealing seam. The sealing effect is generally achieved by fusing the cover film with the container film, i.e., the trough or shell film (lower film), usually by application of additional contact pressure. However, other methods are also known in which, for example, an adhesive layer between the two films which are to be joined together is heated until the films are bonded in a sealing manner.

Heating systems known heretofore for heating the films in the applicable processing devices, such as a shaping and/or sealing device, for example, usually include a temperature-controlled heat source powered by electrical or other means for heating, and for temperature stabilization include a heating element with a sufficiently large mass, and usually also include a cooling system. Such a cooling system frequently includes a piping system using drinking water or process water in order to prevent damage from excessive thermal energy for avoiding excess temperatures of the film to be processed. The heated materials may also be cooled to prevent risk of injury to operators, for example burns as the result of possible contact.

Also known from the prior art is an apparatus from EP 1 228 853 A2 for producing containers in which a welding tool is heated. In this manner heat, which may be inductively generated, for example, is conveyed to the tool. One objective stated in the cited document is to improve the exchangeability compared to the prior art referenced therein by introducing the heating means into a support structure, the support structure allowing insertion of a connecting plate which in turn is in contact with the processing tool, thus permitting the heat inductively generated in the support structure to be conveyed via the corresponding contact surfaces to the connecting plate, and from there to the tool.

### OBJECT AND ADVANTAGES OF THE INVENTION

The object of the present invention is to improve a heating system for a packaging machine according to the prior art described at the outset.

This object is achieved on the basis of the preamble of Claim 1 by means of the characterizing features thereof. Practical and advantageous refinements are stated in the dependent claims.

Accordingly, the present invention relates to a packaging machine for packing packages, preferably trough-shaped packages, to be filled with goods, a heating system being provided for heating a raw material to be shaped into packaging and/or sealing which seals such packaging, in particular for heating a processing tool provided for this purpose. According to the invention, the packaging machine is characterized in that the heating system is designed as an induction heating unit.

In the sense of the present invention, “induction heating unit” is understood to mean a heating system which includes at least one electric coil by means of which a magnetic field having alternating polarization may be generated for producing heat in a material which is electrically conductive and/or which has magnetic properties and which is penetrated by the alternating magnetic field.

An induction heating unit has the advantage that it is able to generate the heat for heating a preheating element for heating the packaging raw material in a contactless manner, and therefore essentially without loss, directly at the location at which the heat is needed.

By associating the heating system, designed as an induction heating unit, with a processing tool the heat supplied thereto for processing or machining the affected packaging or sealing material, which is generally plastic film, may be monitored, i.e., controlled and regulated, very precisely. The processing tool which is typically to be brought into contact with the film being processed may thus be brought to the temperature required for processing the film, essentially without a preheating cycle, at exactly the time that the temperature is needed for initiating the corresponding machining step.

The processing tool may be directly heated if the heating system is provided in such a way that inductively generated eddy currents can be produced in the processing tool by the induction heating. Therefore, in principle it is not necessary to conduct generated heat via contact surfaces or intermediate layers in order to heat the processing tool. It is thus possible to also avoid large heating losses, if applicable. Furthermore, the inductive heating in the heating system may be minimized to the greatest extent possible using the corresponding induction coil(s) themselves. In general, the heating of components of the packaging machine, with the exception of the processing tools to be heated, not only contributes to losses, but for technical and/or safety reasons is also often undesired and must be reduced by cooling, if needed. In addition, as a rule the heating may thus be rapidly produced in the tool, but cooling may also be provided relatively quickly as soon as a heated tool is no longer needed.

Cooling, in particular cooling using a cooling water system, may even be omitted for the packaging machine according to the invention. The induction heating generally allows rapid heating of the processing tool, which as a rule is also able to cool down quickly. In addition, the section in which the induction heating unit or the corresponding induction coils is/are located may be used as external heat shielding for the heated processing tool.

As a result of the comparatively small amount of heating of the raw material to be shaped into packaging, due to the very precisely controllable temperature, as well as the processing tools provided for this purpose, in addition to the film-like raw materials described above other materials such as plastic composites and/or plastic-metal composites may be used.

After the affected material is appropriately heated, the energy input to the affected processing tool may be discontinued, thereby saving energy.

In a first embodiment, a single induction heating unit may be provided for an affected processing tool. The induction heating unit in turn may be provided with a single induction coil, but in one modified embodiment may also have multiple induction coils.

However, depending on the type and size of the packaging to be produced or sealed, multiple processing tools may be heated using a single induction heating unit. This may be meaningful, for example, when multiple processing tools combined as a set, for example, simultaneously produce or seal a plurality of packages.

In a further modified embodiment, two or more processing tools may be designed to be heatable using one or more induction heating units. Here as well, the one or more such heating systems may be equipped with one or more induction coils. Providing multiple induction heating units may have the advantage that, at specific regions of one or more processing tools to be heated, the application of certain temperatures, which optionally may be different in magnitude and/or time sequence from other regions of the processing tools may be carried out in a very targeted manner. This may be advantageous in particular when certain regions of the film to be processed, for example for achieving greater thinning of the film specifically in this region, are to be subjected to more intense and/or longer heating than in other regions. The objective of this procedure is to achieve the most uniform wall thickness possible for the packaging shell thus formed. In principle, processing tools may also be designed in two or more parts.

For machining or processing of the film supplied as raw material, such a packaging machine usually includes machining stations provided along the processing path, each having a corresponding number of processing tools required for the particular machining step. An example of work stations is a so-called shaping or deep-drawing station having an optional preheating station upstream for preheating films which on a short-term basis may not be sufficiently heatable before shaping the film, or a sealing station for sealing packaging which is to be filled with goods and provided with a so-called cover film to be shaped into a finished package.

Depending on the applicable machining step, the processing tools may be designed as a heating plate, shaping tool, and/or sealing tool. According to the particular application, it may be advantageous for the affected processing tool to have only one function, such as preheating, shaping, or sealing. Such a division of the individual tools may be advantageous, for example, for relatively simple package shapes.

For package shapes which may be comparatively more difficult to shape and/or seal, it may be advantageous for the particular processing tool to have a multifunctional use. Possible examples include preheating the film to be processed in a first preheating step, for example preceding the shaping, and maintaining the heating at least in certain film regions during deformation thereof, so that the heating element may also simultaneously function as a shaping tool. The same applies for the sealing process.

It may also be advantageous to provide a thermal insulating region between the heating system, which includes the induction coils, and the processing tool. This thermal insulating region may also prevent or at least limit transfer of thermal energy from the heated processing tool to the heating system together with the induction coils, which could result in losses or possibly additional heating of the coils.

In one variant of the invention, the thermal insulating region may be designed as an air gap, for example.

The processing tool may be mounted using bolts, for example, which advantageously may be made of a thermal insulating material. The heating system may include a housing, for example. The bolts may be attached at the side of the heating system, for example on such a housing. The housing may also be made of a material which is least suitable as an inductive heating unit, i.e., is made of a nonconductive material, contains little or no ferromagnetic material, etc. In addition, this housing may also be made of a thermal insulating material.

In principle, it is also possible to design the thermal insulating region using another material, in particular a solid material such as a thermal insulating plastic, for example.

An improved surface heating effect as a result of the planar distribution of the individual alternating magnetic fields may be achieved by providing multiple induction coils in the heating system. It is thus possible to heat in a very targeted manner essentially only the regions of the affected preheating element and/or the shaping and/or sealing tool by means of which the packaging raw material is to be heated and/or machined in the applicable shaping and/or sealing process.

By use of a matrix configuration it is possible to achieve, for example, large-surface, essentially uniform heating of the affected preheating element and/or shaping and/or sealing tool to be supplied with energy in this manner.

As the result of variability in the position and/or number of induction coils, the induction heating unit according to the invention may be further advantageously adapted to changing production needs, as may be required by changes in format or raw materials, for example. In a particularly advantageous manner the variability affects the localized configuration as well as the number and/or intensity and/or orientation of the individual induction coils.

A change in the intensity of the alternating field generated by the induction coil may be achieved in particular by designing the induction coils as exchangeable elements. Provided that the spatial dimensions of the induction coils, which differ in intensity, are similar enough to one another that their position in a housing provided for accommodating the particular induction coils is not important, the induction coils may also be easily varied and/or exchanged in the sense described above.

In one particularly preferred embodiment, the position and/or orientation of the induction coils is selected in such a way that essentially only one or more specific regions of the preheating element and/or the shaping and/or sealing tool to be heated by same are heated. This may be achieved by preheating the usually film-like raw material, thus allowing targeted preheating of the deformation regions which for the particular machining process are critical in achieving an improved, in particular uniform, reduction in thickness. In this manner, for example regions which cool rapidly, typically using deep-drawing, such as the regions of the side walls of a packaging trough to be shaped, may be supplied with heat at a somewhat higher intensity and/or in particular also for a longer time than for regions at edges and corners, for example. An otherwise more intense thinning of the material layers in the edge and corner regions as the result of solidified and thus no longer deformable surface regions may thus be advantageously achieved at the side walls and/or the base of the packaging container to be shaped.

In one possible embodiment, for this purpose surface regions of deep-drawing molds may be heated essentially in only a small layer depth in the regions at which the film to be deep-drawn is applied for forming the packaging container to be produced. The heat input may be discontinued immediately after completion of the deformation process, so that the remaining material portions of the shaping tool which are still cool, or even cold, and the layer regions which are heated for a short time by the induction heating unit, and in particular the deep-drawn film in contact with same, rapidly cool and harden in a dimensionally stable manner. In addition to the influence on the position and/or number of induction coils and optionally the orientation thereof, it is also possible to influence the operating parameters of the induction coil such as the frequency and/or voltage and/or current intensity, and/or from the direction and/or intensity of the magnetic field to provide means to be advantageously influenced, for example the configuration of ferromagnetic elements.

Depending on the desired heat input to the packaging material to be processed, process optimization is thus possible due to the ability to influence various parameters, such as the quantity of thermal energy introduced in a given region of a preheating element, in particular a shaping tool for deforming the material, for example by means of the mass of the shaping tool which is heated as a function of the heated layer depth, and/or via the variation over time of the heat input into a corresponding region of the tool.

A packaging machine designed according to the invention may thus be operated with an energy demand for heating which is comparatively greatly reduced. A further significant advantage lies in the omission of a cooling system which heretofore has usually been required. This has a positive effect with regard to purchasing and operating outlays, and in particular with regard to the space demands thus no longer required. In addition, the use of comparatively more economical raw materials, such as the plastic composites and/or plastic-metal composites mentioned above, is a positive effect of the present invention.

Temperature regulation is also essential since, depending on the film used and the respective packaging to be produced, applicable parameters may be determined once and maintained for access in a corresponding shaping process. The preheating elements and/or shaping and/or sealing tools are then always correspondingly supplied with the same quantity of energy, thus allowing a stable process sequence.

For the start-up operation of the packaging machine, factorization of individual parameters may optionally be provided, whereby for each particular combination of packaging raw material, number and/or type of preheating elements and/or shaping and/or sealing tools, and/or a temperature relating to the apparatus a corresponding value table may be stored, for example in a memory preferably associated with the machine control system.

Providing a control unit for the individual and/or grouped actuation of induction coils allows a very targeted influence on the quantity and/or variation over time of the thermal energy introduced into the applicable process step by the respective induction coil. In this manner, for example for a mechanically unchanged design, various packaging raw materials possibly having different machining requirements may also be processed in a particularly advantageous manner.

In one preferred embodiment, the mechanical implementation may be provided in such a way that, depending on the design of the preheating element and/or shaping and/or sealing tool to be heated thereby and/or an element or tool which complements same, the induction coils may be provided directly in and/or on these elements or tools.

In one possible embodiment the preheating element may be designed, for example, as a heating plate for heating the raw film to be deformed which comes into direct contact with the raw film and which has induction coils flatly distributed on the back side according to the above description. In order to apply the appropriate thermal energy to the film by means of the heating plate according to the invention, the heat input may be optimized to the process in such a way that energy is introduced by inductive heating of the heating plate only when it is also definitively possible for a subsequent deep-drawing process to take place. During the down times which interrupt the machine cycle it is not necessary to preheat the heating plate, thereby reducing the primary energy consumption. It is also advantageous that impermissible overheating of the film which in such cases may have occurred heretofore is thereby avoided.

These advantages are realized for the primary preheating element, which is provided on the shaping tool in such a way that the preheating element is directly upstream from the deep-drawing process, as well as for a second preheating element which is also optionally provided and which, for example, may also be referred to as a “preheating element” and is installed upstream from the primary preheating element in the processing direction of the film web.

In special embodiments, such a preheating element may also have two heating plates which are oppositely situated and which enclose the film to be heated in the manner of a sandwich.

In one possible embodiment, a separate induction heating unit may be provided for each of the two plates. In one particularly preferred embodiment only one induction heating unit is provided. This induction heating unit is located on the back side of one of the two heating plates, and heats the directly adjacent heating plate as well as the heating plate on the other side of the film.

In a further modified embodiment the heating plate may also be designed as an elastically deformable plate which is able to support the shaping tool, for example for assisting the motion of the region of the film to be deformed for the packaging which is heated by the heating plate, during the deep-drawing process, particularly preferably with an extension of the time period for heat delivery from the heating plate to the film to be deformed. In this manner, in particular in the film regions which cool first due to contact with the shaping tool, the temperature required for the flow characteristic of the film may be maintained for a longer period. This applies in particular to the large-surface regions such as the wall and base of the trough- or shell-shaped packaging container to be shaped.

In a further preferred embodiment the inductive heating unit may also be accommodated in a shaping tool having a stamp-like shape. It is thus possible to achieve a comparatively long period of heat transmission to the film to be deformed, in particular for difficult contours, so that the heated stamp-shaped tool contacts the shaped film until the film solidifies, if necessary. The time at which the inductive heating unit is shut off may vary, depending on the embodiment. In particular it is also possible to heat certain critical regions of the film to be deformed for longer periods than for other regions.

In one embodiment in which the regions of the stamp-shaped shaping tool coming into contact with the film to be processed are composed essentially of a nonconductive material, it is possible, for example, to inductively heat a complementary, optionally shell-shaped, shaping tool while the stamp is being inserted into this shaping tool. In this manner the complementary shell-shaped shaping tool may be heated to such an extent in its outer layer regions facing the film to be deformed that dropping of the film temperature below the solidification temperature is retarded, thus assisting in positively influencing a uniform reduction in layer thickness of the film to be deformed.

Alternatively or additionally, ferromagnetic materials may be introduced in the regions of the stamp-shaped shaping tool in which comparatively small deformations of the material to be shaped into packaging come into contact. This allows additional heating of these surface regions by the effect of the induction heating in the above-described sense, so that material is able to flow from the subsequent large-surface wall regions into the critical edge and corner regions of the packaging to be shaped, thereby avoiding critical material thinning at those locations.

In particularly preferred embodiments the preheating element and/or the shaping and/or sealing tool are made of ferromagnetic material, or at least are combined with same. Corrosion-resistant ferromagnetic materials may thus be used in a particularly advantageous manner. Problem-free use of the packaging machine in the food and medical industries is thus possible.

Also possible in principle, however, is the use of aluminum-containing materials, with the tradeoff of correspondingly less favorable energy efficiency due to the poorer heating characteristic of the aluminum compared to ferromagnetic materials.

### EXEMPLARY EMBODIMENT

The figures show the following:

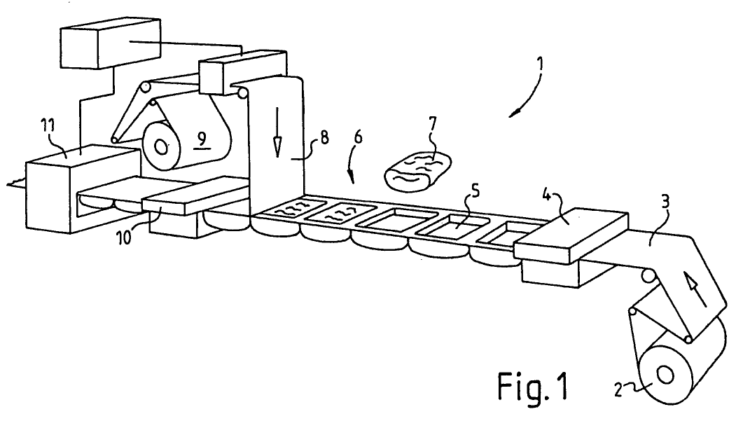

FIG. 1 shows a schematic perspective illustration of one possible embodiment of a packaging machine;

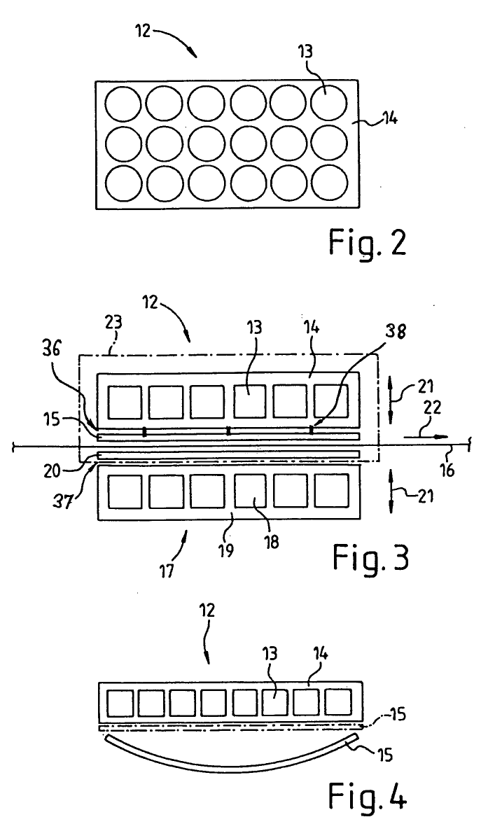

FIGS. 2-4 show an induction heating unit according to the invention for a preheating element for heating a film to be deformed into trough-shaped packaging, in various illustrations and embodiments;

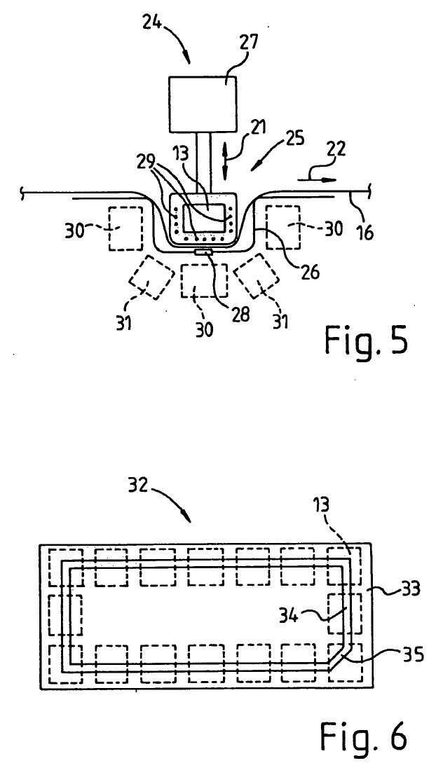

FIG. 5 schematically shows an example of a shaping tool in a sectional illustration; and

FIG. 6 schematically shows an example of a sealing tool in a top view.

The packaging machine 1 according to FIG. 1 represents a deep-drawing machine which draws off the so-called low web or also trough film 3 from a film roll 2. The trough film 3 is shaped in a shaping tool 4 under the influence of heat and also optionally pressure, particularly preferably under vacuum, to produce packaging troughs 5. The packaging troughs 5 are manually or automatically filled with goods 7 in a filling line 6. A cover film 8 is drawn off from a feed roll 9 and placed as a cover on the packaging troughs 5. The cover film 8 is combined with and sealed to the packaging trough 5 in a sealing tool 10. In a cutting unit 11 individual connected packages produced in the preceding production process are separated into individual packages.

FIG. 2 schematically shows a top view of a heating system, for example for a preheating element for preheating a film to be deformed into a packaging trough. According to the invention, this heating system 12 includes electric coils 13, configured in a matrix in a housing 14, as the first essential elements of the heating system 12 provided as an induction heating unit according to the invention. As the result of this flat distribution of the coils 13 it is possible to generate a relatively planar electromagnetic field for heating the heating plate 15, preferably containing ferromagnetic metal materials, situated on the end face side thereof according to the illustration in FIG. 3.

The housings 14 and 19 for the respective heating systems 12 and 17 are separated at a distance from the corresponding heating plates 15 and 20. These intermediate regions 36, 37 between the respective housings 14, 19 and the corresponding heating plates 15, 20 are provided for heat insulation via air gaps. The heating plate 15 is mounted to the corresponding housing 14 by means of bolts 38.

The heating plate 15 for heating the film to be deformed into a packaging trough after the heating process is usually in direct contact with the film. The exact temperature to which the heating plate is also to be heated is thus supplied to the film. To prevent damage to the film 16 by frictional or sliding contact while moving in the transport direction according to arrow 22, the heating system 12 together with the heating plate 15 may be moved toward the film according to arrow direction 21 for initiating the heating process, and then moved away from the film.

By varying the operating parameters of the electric coils 13, such as the frequency and/or voltage, the heat generated in the heating plate 15 from the resulting magnetic field may be produced very quickly, and also controlled very precisely with regard to its penetration as well as temperature. In a further advantageous manner the mass of the heating plate 15 may be kept very low, which has an additional advantageous effect on generation and delivery of the heat in a comparatively narrow temperature range due to the low temperature fluctuation associated with the low mass.

To allow the film 16 to be uniformly heated from both sides, by way of example for a further embodiment an additional heating system 17 having electric coils 18 in a housing 19 and having a heating plate 20 is provided on the underside of the film. This additional heating system as well may be moved toward the film 16 for heating same, according to arrow directions 21, and then moved away from the film. However, the film may also be passed between two heating plates, of which at least one but preferably both are fixed in position so that their distance to the film, i.e., the raw material to be deformed into packaging, may be firmly specified.

In one particularly preferred embodiment, a heating plate 15 situated on one side of the film 16 as well as a heating plate 20 situated on the opposite side of the film are inductively heated by electric coils 13, corresponding to the sandwich-like heating system collectively denoted by the frame 23 shown in dashed-dotted lines.

FIG. 4 illustrates a further modified embodiment of the heating system 12 in which the heating plate 15 is designed as a flexible, elastically deformable heating plate. Such a heating system 12 may be provided, for example, in cooperation with a shell-shaped shaping tool (not illustrated here) for deformation of the film heated by the heating plate 15. As described above, the heating plate 15 is first heated by the electromagnetic field induced therein by the electric coils 13 in the position illustrated by dashed-dotted lines in order to correspondingly heat the film applied thereto. After the film is sufficiently heated, the heating plate 15 is able to push the heated film, for example in a type of snap motion, in the direction of the shaping tool which accepts the film for the deformation. In a particularly advantageous manner the heating plate 15, which still contains thermal energy, remains in contact with the film so that the film is kept for as long as possible in the temperature range in which it is free-flowing. Material from the frequently large-surface regions which otherwise undergo little or no deformation may thus be advantageously distorted in the direction of any shaped region in which comparatively large deformations and thus an accompanying large material thinning occurs, such as at corners and edges, for example.

FIG. 5 schematically shows by way of example a sectional illustration of a shaping apparatus 24. This shaping apparatus includes a stamp-shaped shaping tool 25 and a shell-shaped shaping tool 26 for producing a shell- or trough-shaped packaging container from the film 16 deformed in this manner.

In this embodiment an electric coil 13 is once again provided in the stamp-shaped shaping tool 25. In this manner a magnetic field may be generated which is able to cause heating of the wall regions of the shell-shaped shaping tool 26 covered by the generated magnetic field, at least in the outer layers thereof, for example when the previously preheated film 16 is pressed into the shell-shaped tool 26. Once again it is possible to retard a drop in the temperature of the film below the temperature range in which it remains free-flowing. Without such heating, the film would immediately cool and solidify on the otherwise cold surface of the shell-shaped shaping tool 26.

A further advantage of providing an electric coil 13 in this stamp-shaped shaping tool 25 actuated by the drive 27 lies in the inductive heating of a block 28, illustrated here by way of example, situated in the base region of the shell-shaped shaping tool 26. In this manner the film may be kept in its free-flowing state for a comparatively longer time, in the same sense as described above, by avoiding a temperature drop which would otherwise occur.

The stamp-shaped shaping tool 25 is usually made of a nonconductive material. To allow additional thermal energy to be introduced into the film 16 to be deformed in this case and applied during the deformation process, the stamp-shaped shaping tool 25 may be provided with inclusions 29 of inductively heatable, preferably ferromagnetic, materials in order to supply additional heat to the affected wall regions of the stamp-shaped shaping tool 25 by means of the electromagnetic field generated by the coil 13. The inductively heatable materials may optionally be situated so that they may be in direct contact with the film 16 for better heat transfer. In a particularly preferred manner, once again surface regions are heated in which retardation of the film solidification is desired.

A further possibility for inductive heating of the shell-shaped shaping tool 26 consists in providing electric coils 30 at the side facing away from the film to be deformed. To enable the corner and/or edge regions of the shaping tool 26 to also be heated as uniformly as possible, additional coils 31 may be provided in these regions. Further improvement in the temperature control for the deformation of the film may be achieved by separately actuating the individual coils. This applies in principle to all embodiments described herein.

FIG. 6 schematically shows by way of example a top view of a sealing tool 32 provided at the sealing station 10 for sealing a packaging trough 5 filled with goods 7 according to the illustration in FIG. 1. The sealing tool 32 has a sealing contour 34 made of an inductively heatable, preferably ferromagnetic, metal. The housing 33 may basically be made of any suitable material. The energy input for producing heat in the sealing contour 34 is achieved here as well by actuation of electric coils 13, in the same manner as for the embodiments described above. In this case the electric coils, illustrated by way of example in dashed lines, are situated in a ring-shaped pattern in the housing 33, behind the sealing contour 34. The sealing contour 34, illustrated here in an essentially rectangular shape as an example, has a bevel 35 at one corner to form a “pull-off corner” on the package.

For all the inductively heated heating or shaping elements herein, it is advantageous that the elements may be made of a material which is comparatively thin and which therefore has low mass, preferably ferromagnetic material. On the one hand, this results in savings in the energy required for heating the affected tools. On the other hand, the inductive heating also allows a very precise temperature influence on the processing operation for the film to be deformed to produce packaging, and in a further advantageous manner, for any cooling system as well.

### LIST OF REFERENCE NUMERALS

1 Packaging machine
2 Film roll
3 Trough film
4 Shaping apparatus
5 Packaging troughs
6 Filling line
7 Goods
8 Cover film
9 Film roll
10 Sealing apparatus
11 Cutting unit
12 Heating system
13 Electric coil
14 Housing
15 Heating plate
16 Film
17 Heating system
18 Electric coil
19 Housing
20 Heating plate
21 Arrow
22 Arrow
23 Sandwich heating system
24 Shaping apparatus
25 Stamp-shaped shaping tool
26 Shell-shaped shaping tool
27 Drive
28 Block
29 Material inclusion
30 Electric coil
31 Electric coil
32 Sealing tool
33 Housing
34 Sealing contour
35 Tear-off corner
36 Air gap
37 Air gap
38 Bolt

What is claimed is:

1. Packaging machine for packaging packages, preferably trough-shaped packages, to be filled with goods, wherein a heating system is provided, characterized in that the heating system is designed as an induction heating unit which is associated with a processing tool, and wherein the induction heating unit is provided in such a way that inductively generated eddy currents may be produced in the processing tool by the induction heating unit in order to directly heat the processing tool.

2. Packaging machine according to one of the preceding claims, characterized in that the processing tool may be heated by an induction heating unit.

3. Packaging machine according to one of the preceding claims, characterized in that two or more processing tools may be heated by one or more induction heating units.

4. Packaging machine according to one of the preceding claims, characterized in that the processing tool is designed as a heating plate.

5. Packaging machine according to one of the preceding claims, characterized in that the processing tool is designed as a shaping tool.

6. Packaging machine according to one of the preceding claims, characterized in that the processing tool is designed as a sealing tool.

7. Packaging machine according to one of the preceding claims, characterized in that a thermal insulating region is provided, at least in places, between the heating system and the processing tool.

8. Packaging machine according to one of the preceding claims, characterized in that the thermal insulating region is designed as an air gap.

9. Packaging machine according to one of the preceding claims, characterized in that the heating system is connected to the processing tool by means of bolts, for example thermal insulating bolts.

10. Packaging machine according to one of the preceding claims, characterized in that the thermal insulating region is made of a thermal insulating material, for example a thermal insulating plastic.

11. Packaging machine according to one of the preceding claims, characterized in that the heating system includes multiple induction coils.

12. Packaging machine according to one of the preceding claims, characterized in that the induction coils are configured in a matrix.

13. Packaging machine according to one of the preceding claims, characterized in that the position and/or number of the induction coils may be varied.

14. Packaging machine according to one of the preceding claims, characterized in that the induction coils are designed as exchangeable elements.

15. Packaging machine according to one of the preceding claims, characterized in that the position and/or orientation of the induction coils are selected in such a way that essentially only one or more specific regions of the preheating element and/or the shaping and/or sealing tool to be heated by same are heated.

16. Packaging machine according to one of the preceding claims, characterized in that the control parameters for operating the induction coils may be specified in such a way that essentially only a specific layer depth of the preheating element and/or the shaping and/or sealing tool to be heated is heated.

17. Packaging machine according to one of the preceding claims, characterized in that a control unit is provided for the individual and/or grouped actuation of the induction coils.

18. Packaging machine according to one of the preceding claims, characterized in that the control unit is designed to vary the control parameters for the induction coils.

19. Packaging machine according to one of the preceding claims, characterized in that the induction coils are provided in and/or on the processing tool.

20. Packaging machine according to one of the preceding claims, characterized in that the induction coils are provided in and/or on a tool which complements the processing tool.

21. Packaging machine according to one of the preceding claims, characterized in that two heating plates are provided in the manner of a sandwich with respect to the material to be processed into packaging.

22. Packaging machine according to one of the preceding claims, characterized in that the heating plate is designed as an elastically deformable plate.

23. Packaging machine according to one of the preceding claims, characterized in that a shaping tool has a stamp-shaped design.

24. Packaging machine according to one of the preceding claims, characterized in that the region of the stamp-shaped shaping tool coming into contact with the material to be processed into packaging is composed essentially of a nonconductive material.

25. Packaging machine according to one of the preceding claims, characterized in that the region of the stamp-shaped shaping tool coming into contact with the material to be processed into packaging contains inductively heatable materials in the regions in which comparatively small deformations of the material to be shaped into packaging come into contact.

26. Packaging machine according to one of the preceding claims, characterized in that the processing tool contains, at least in places, a material which is electrically conductive and/or which has magnetic properties.

27. Packaging machine according to one of the preceding claims, characterized in that the processing tool is coated at least in places.

28. Packaging machine according to one of the preceding claims, characterized in that a shaping tool has a trough-shaped design.
